(19) United States
(12) Patent Application Publication
(10) Pub. No.: US 2011/0243630 A1
(43) Pub. Date: Oct. 6, 2011

(54) INFORMATION PROCESSING SYSTEM, KEYBOARD SYSTEM, AND KEY TOP SYSTEM

(75) Inventor: Kenji URITA, Kawasaki (JP)

(73) Assignee: Fujitsu Limited

(21) Appl. No.: 13/158,030

(22) Filed: Jun. 10, 2011

Related U.S. Application Data
(63) Continuation of application No. PCT/JP2009/050304, filed on Jan. 13, 2009.

(51) Int. Cl. B41J 5/08

(52) U.S. Cl. 400/490

(57) ABSTRACT

An information processing system includes: a first information processing device including a first keyboard with a first key top; and a second information processing device including a second keyboard with a second key top, wherein a first character is denoted on the first key top, and a cold color is more similar to a color of the first character than to a background color, wherein a second character is denoted on the second key top, a warm color is more similar to a color of the second character than to a background color, and the second character is the same to the first character, and wherein an area of the first character is smaller than an area of the second character.

### CROSS-REFERENCE TO RELATED APPLICATION

This application is based upon and claims the benefit of priority of the prior International Patent Application No. PCT/JP2009/050304, filed on Jan. 13, 2009, the entire contents of which are incorporated herein by reference.

### FIELD

The embodiment discussed herein is related to an information processing system, a keyboard system, and a key top system.

### BACKGROUND

A keyboard used for input to an electronic device is provided with plural key tops. Characters are denoted on each of the key tops (Japanese Patent Application publication No. 2007-264977).

In such a keyboard, there may be color variation models different from each other in color. In cases where such keyboards including the color variation models are intended to be sold for a specific group of consumers, it is desirable that the models different in color should give uniform impressions to the consumers. The specific group of consumers is classified by, for example, age. If the keyboards different in color give different impressions to the consumers, although the target consumers are focused on the specific class of consumers, the difference in the number of sales between the models might be increased in the specific group of consumers.

### SUMMARY

According to an aspect of the embodiments, an information processing system described herein includes: a first information processing device including a first keyboard with a first key top; and a second information processing device including a second keyboard with a second key top, wherein a first character is denoted on the first key top, and a cold color is more similar to a color of the first character than to a background color, wherein a second character is denoted on the second key top, a warm color is more similar to a color of the second character than to a background color, and the second character is the same to the first character, and wherein an area of the first character is smaller than an area of the second character.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exemplary view of notebook computers;

FIG. 2 is a comparative view of key tops;

FIG. 3 is a comparative view of key tops each having a character of the same size; and

FIG. 4 is a comparative view of key tops provided in notebook computers according to a second embodiment.

### DESCRIPTION OF EMBODIMENTS

Embodiments according to the present invention will be described below with reference to the accompanying drawings.

### First Embodiment

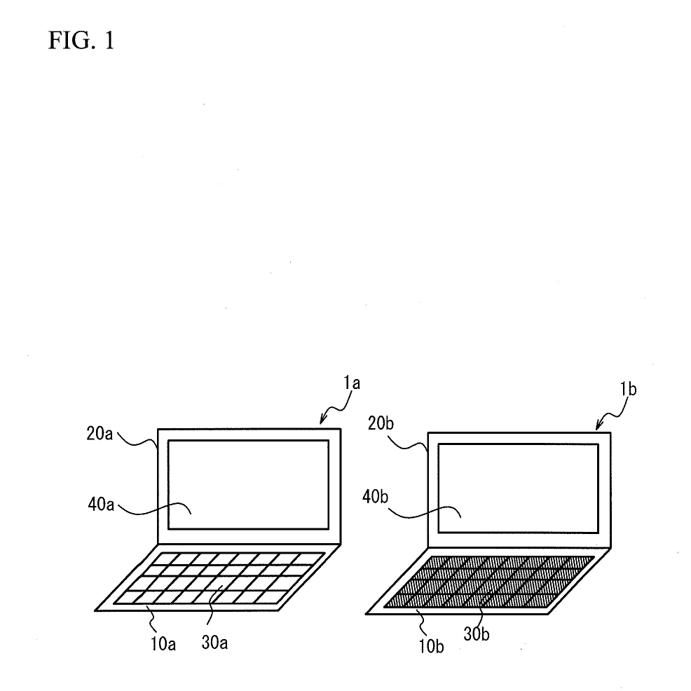

An information processing system according to a first embodiment will be explained. Two notebook computers will be described as an example of an information processing system. FIG. 1 is an exemplary view of notebook computers. Notebook computers 1a and 1b are examples of information processing devices. As illustrated in FIG. 1, the notebook computer 1a includes: a main portion 10a; and a display portion 20a openably and closably connected to the main portion 10a. A motherboard to control the whole operation of the notebook computer la is built in the main portion 10a. Also, a keyboard 30a functioning as an input device is provided in the main portion 10a. A display 40a is provided in the display portion 20a. A desired image is displayed on the display 40a in response to the input operation into the keyboard 30a.

Like the notebook computer la, the notebook computer lb includes a main portion 10b, a display portion 20b, a keyboard 30b, and a display 40b. The keyboards 30a and 30b are different in color from each other. The keyboards 30a and 30b are respectively provided with key tops different in color from each other.

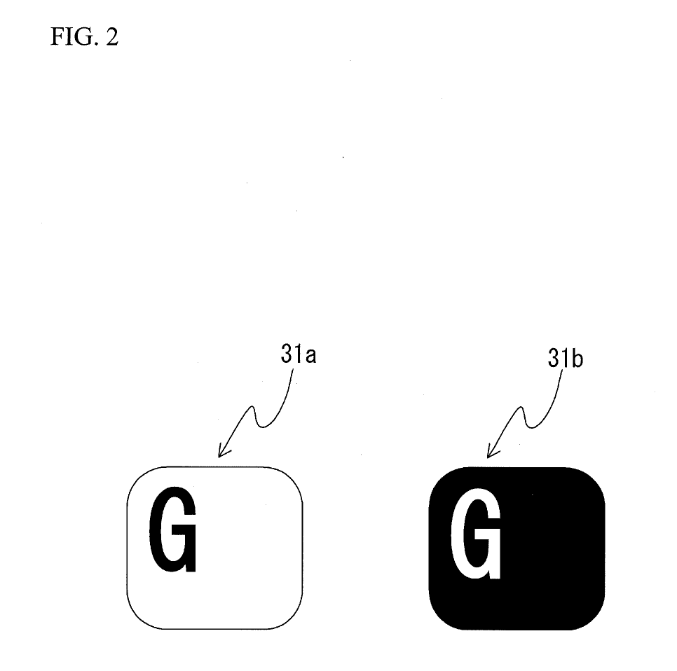

FIG. 2 is a comparative view of the key tops. As illustrated in FIG. 2, a key top 31a is an example of a key top provided in the keyboard 30a, and a key top 31b is an example of a key top provided in the keyboard 30b. The key tops 31a and 31b each have the same shape and the same size. On the key tops 31a and 31b, a letter of “G” as the same character is denoted. Additionally, the character includes signs in addition to letters.

In the key top 31a, a cold color is more similar to a color of the character than to a background color. For example, the color of the character of the key top 31a is black that is one of cold colors, and the background color is white that is one of warm colors.

In the key top 31b, a warm color is more similar to a color of the character than to a background color. For example, a color of the character of the key top 31b is the white that is one of warm colors, and a background color is black that is one of cold colors. For example, the character color of the key top 31a and the background color of the key top 31b are the same, and the character color of the key top 31b and the background color of the key top 31a are the same.

The area of the character of the key top 31a is smaller than that of the character of the key top 31b. Specifically, the size of the character of the key top 31a is smaller than that of the character of the key top 31b. This reason will be described later.

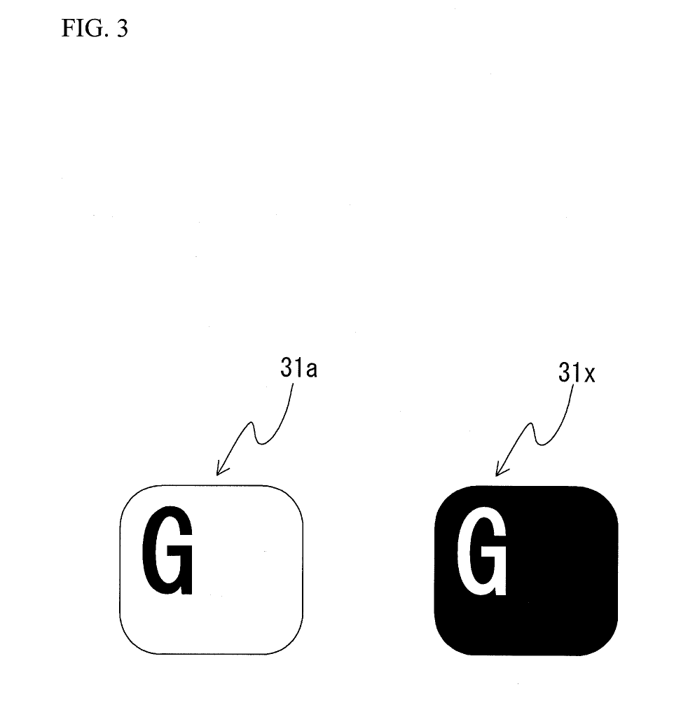

FIG. 3 is a comparative view of key tops each having a character of the same size. Both sizes of the characters “G” denoted on the key tops 31a and 31x are the same. The character of the key top 31x looks like smaller than the character of the key top 31a.

This is caused by an optical illusion. The sizes of the warm colors look more expanded than the actual sizes by the optical illusion. The sizes of the cold colors look more shrunk than the actual sizes. Thus, the warm color is more similar to the color of the character of the key top 31b than to the background color. Therefore, the character of the key top 31b looks constricted by the background, and looks smaller than the actual size. On the other hand, a cold color is more similar to the color of the character of the key top 31a than to the background color. Therefore, the character of the key top 31a looks expanded in the background, and looks larger than the actual size.

Thus, in the key tops 31a and 31b according to the present embodiment, the character of the key top 31a is smaller than the character of the key top 31b.

Therefore, the sizes of the characters of the key tops 31a and 31b look substantially the same. Thus, the key tops 31a and 31b have a sense of unity. In contrast, in cases where the sizes of the characters of the key tops 31a and 31x are the same as illustrated in FIG. 3, the sizes of the characters look different, thereby lacking in a sense of unity.

The process of making such an invention will be described. This inventor found that the impressions are different depending on a combination of a background color of a key top and a character color, even if keyboards are the same size and the same shape. This inventor found that the difference in impression is caused by the optical illusion depending on the difference between the character color and the background color of the key top. This inventor also found that the sizes of the characters look different due to the optical illusion.

This inventor discovered the following problems based on the difference in impression. For example, in cases where impressions of keyboards with the same shape are different and such keyboards are sold for a specific group of consumers, the inventor found that the difference in impression might influence the difference in the number of the sales.

For example, in cases where the group of consumers is set to seniors, the character of the key top 31x looks smaller than that of the key top 31a. Thus, a keyboard having a key top where a warm color is more similar to the color of the character than to the background color, gives an impression that it is difficult for the keyboard to be used. On the other hand, a keyboard having a key top where a cold color is more similar to a color of a character than to a background color, gives an impression that it is easy for the keyboard to be used. Further, such color variation models are usually sold with adjacently to each other. This emphasizes the difference in impression between the models. This inventor found the above problem and made the present invention.

### Second Embodiment

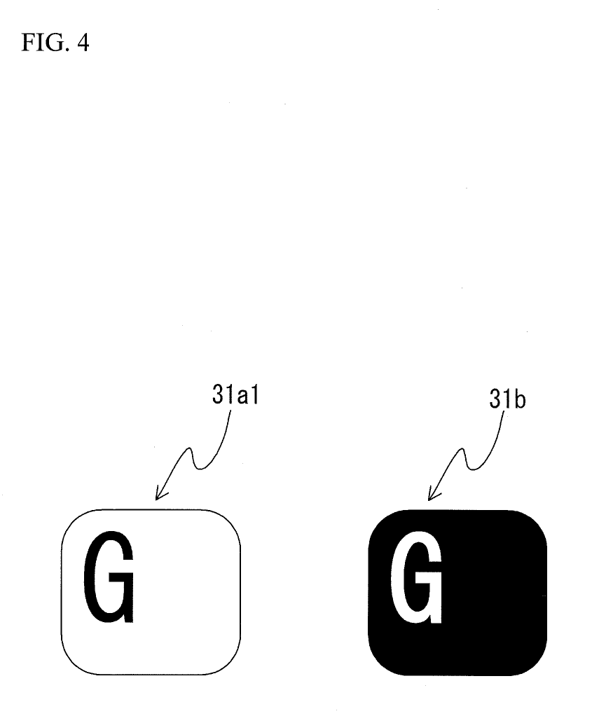

Next, an information processing system according to the second embodiment will be described. Like the first Embodiment, notebook computers will be described as an example of an information processing system in the second Embodiment. FIG. 4 is a comparative view of key tops provided in notebook computers according to the second embodiment. The line thickness of the character of a key top 31a1 is thinner than that of the key top 31b. In this case, by the optical illusion, the line thickness of the character of the key top 31a1 looks thicker than the actual line thickness, and the line thickness of the character of the key top 31b looks thinner than the actual line thickness. Therefore, each line thickness of the characters of the key tops 31a1 and 31b looks the same, thereby ensuring a sense of unity.

In the above embodiments, the keyboard employed in the notebook computer has been described. However, the above key tops may be employed in a keyboard of a desktop computer. The above key tops may be employed in a single keyboard.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the sprit and scope of the invention.

What is claimed is:

1. An information processing system comprising:
a first information processing device comprising a first keyboard with a first key top; and
a second information processing device comprising a second keyboard with a second key top,
wherein a first character is denoted on the first key top, and a cold color is more similar to a color of the first character than to a background color,
wherein a second character is denoted on the second key top, a warm color is more similar to a color of the second character than to a background color, and the second character is the same to the first character, and
wherein an area of the first character is smaller than an area of the second character.

2. The information processing system of claim 1, wherein a size of the first character is smaller than a size of the second character.

3. The information processing system of claim 1, wherein a thickness of the first character is thinner than a thickness of the second character.

4. The information processing system of claim 1, wherein the color of the first character and the background color of the second key top are the same.

5. The information processing system of claim 1, wherein the color of the second character and the background color of the first key top are the same.

6. A keyboard system comprising:
a first keyboard with a first key top; and
a second keyboard with a second key top,
wherein a first character is denoted on the first key top, and a cold color is more similar to a color of the first character than to a background color,
wherein a second character is denoted on the second key top, a warm color is more similar to a color of the second character than to a background color, and the second character is the same to the first character, and
wherein an area of the first character is smaller than an area of the second character.

7. A key top system comprising:
a first key top; and
a second key top,
wherein a first character is denoted on the first key top, and a cold color is more similar to a color of the first character than to a background color,
wherein a second character is denoted on the second key top, a warm color is more similar to a color of the second character than to a background color, and the second character is the same to the first character, and
wherein an area of the first character is smaller than an area of the second character.
